(19) United States
(12) Patent Application Publication
(10) Pub. No.: US 2008/0137622 A1
(43) Pub. Date: Jun. 12, 2008

(54) Method and System for Connecting to a Network Via a Wireless Local Area Network

(76) Inventor: Levi Russell, Middlesex (GB)

Correspondence Address: SCHWEGMAN, LUNDBERG & WOESSNER, P.A., P.O. BOX 2938, MINNEAPOLIS, MN, 55402, US

(21) Appl. No.: 11/661,024

(22) PCT Filed: Aug. 25, 2005
(86) PCT No.: PCT/GB05/03301

§ 371 Date: Oct. 24, 2007

(30) Foreign Application Priority Data
Aug. 25, 2004 (GB) 0418957.7
Feb. 5, 2005 (GB) 0502452.6
Feb. 5, 2005 (GB) 0502454.2

(51) Int. Cl. H04Q 7/24

(52) U.S. Cl. 370/338

(57) ABSTRACT

A method of and a system (1) for connecting a wireless enabled device (9) to a network, such as the Internet (13), is disclosed. The system (1) comprises a wireless access point (3) connected to the Internet (13), a server (15) and storage means (17). The wireless access point (3) comprises a base station (7) for providing the wireless connection to the wireless enabled device (9) and a wireless access point controller (5) for controlling the connection of the wireless enabled device (9) to the Internet (13). The wireless access point (3) is commissioned by downloading and installing software from the server (15). The server (15) is connected to the wireless access point (3) via the Internet (13), and is used to authenticate the connection of the wireless enabled device (9) to the Internet (13) based on information stored in the storage means (17). A method of satisfying demand for a service in a specified geographical area is described.

This invention relates to a method of and a system for connecting to a network via a wireless local area network (WLAN). In particular it relates to a method of and a system for connecting to the Internet via a WLAN.

Computers and other electronic devices can be connected wirelessly to form a WLAN. Such WLANs are common in both residential and commercial properties. For example, a desktop computer can be wirelessly connected to a laptop by installing a wireless adaptor in both devices. Similarly, handheld devices, such as personal digital assistants (PDAs), can be connected wirelessly to these devices. Such WLANs are easily set up, as there is no need to run wires between wireless enabled devices, and can be implemented to share resources between such devices. A common use of a wireless network in a home enables sharing of an Internet access point between two or more computers.

Interoperability of WLAN products is based on industry standards such as the IEE 802.11 specification (“Wi-Fi”®) and the Bluetooth® specification. Public WLAN access points, known as “hotspots”, are found in locations such as airports, cafés, hotels and petrol stations, and allow the user of a wireless enabled device to connect to the Internet.

Many hotspot operators require users of wireless enabled devices to subscribe to the operator's service before allowing access to the Internet through their public WLAN access points. Generally speaking, such public WLAN access points are installed and maintained at a particular site by the public WLAN access point operator, rather than the owner of the site. Hence, the installation of these public WLAN access points is concentrated in and around the type of locations identified above, where the resident or owner of such locations desires to provide such public WLAN access points and/or the public WLAN access point operator believes they will generate significant revenue by placing a public WLAN access point at that location. The cost of installing and maintaining these commercial public WLAN access points inhibits comprehensive geographical coverage of many residential and commercial areas to such locations, due to the limited range of each access point. Therefore, if the user of a wireless enabled device wishes to connect to the Internet through a public WLAN access point, they must be in close geographical proximity to such a public WLAN access point.

Internet access is commonly provided either by means of a dial-up connection to an Internet service provider (ISP), or by subscription to a dedicated subscriber line to the ISP, such as ADSL (commonly known as “Broadband”). Broadband Internet access provides a high bandwidth connection between a user and their ISP, with connection rates typically of 1 or 2 mega bits per second (Mbps). Due to the sporadic nature of the bandwidth requirement of Internet use, the bandwidth available to Broadband subscribers is seldom used to its full capacity, and sharing of a subscriber line between two or more Internet users provides an economical use of such subscriber lines, subject to contractual constraints between the subscriber and the ISP, without adversely affecting the bandwidth available to a user at any one time.

Creating a local area network between neighbours to share a Broadband subscription is most easily done using a WLAN. This invention provides a system for commissioning and controlling and a method of connecting to the Internet through a WLAN which allows sharing of a Broadband line between multiple users while providing income to the subscriber of the Broadband line. This feature of the invention allows a Broadband subscriber to turn his Broadband line into a public WLAN access point. As well as providing an income to the Broadband subscriber, this system also prevents unauthorised access to the subscriber's Broadband line by controlling access to the resources of the ISP. The issue of controlling unauthorised access is becoming more and more important as the practice of exploiting other people's Broadband access is on the rise. The act of dishonestly obtaining an electronic communications service without the consent of the service subscriber is illegal in many jurisdictions, and this invention provides a further advantage that it can reduce the number of offenders of this law, by controlling access to a digital subscriber line, thereby making it harder for unauthorised users to access such WLANs while at the same time providing a legal manner in which to connect to the Broadband service.

A further advantage of this invention is that residential or commercial users with commonly available wireless enabled devices can provide public WLAN access points from their own property, without enlisting the services of commercial public WLAN access point providers. This invention provides an opportunity to greatly increase the geographical coverage of public WLAN access points, thereby providing high bandwidth Internet access at many more locations.

According to a first aspect of the invention there is provided a system for commissioning and controlling a wireless access point providing authenticated connection of a wireless enabled device to a network, the system comprising: a server accessible over the network by said wireless access point; and storage means accessible by the server; wherein the storage means stores software downloadable to the wireless access point, the software providing means for the wireless access point to check with the server if said wireless enabled device can be connected to the network through the wireless access point; and wherein the storage means stores subscription information accessible by the server to authenticate connection of said wireless enabled device to the network through the wireless access point.

Preferably the server comprises means for testing bandwidth available at the wireless access point. Preferably the storage means stores information about the wireless access point such as the bandwidth available at the wireless access point and the location of the wireless access point.

Preferably the system comprises means for registering the demand for a wireless access point in a specified geographical area and the level of the demand is stored in the storage means.

Preferably the system further comprises means for measuring usage information relating to connection of a wireless enabled device to the network through a wireless access point, the measured usage information being stored in the storage means. This enables billing of the end user of the wireless enabled device and remuneration to be paid to the operator of the wireless access point.

Preferably information stored in the storage means can be accessed over the network and viewed using a web browser. For example, potential end users of wireless enabled devices can enquire about the location of their nearest wireless access point and the bandwidth available at different wireless access points. Similarly, potential operators of wireless access points can enquire about the demand for a wireless access point in their area.

Preferably the wireless access point is in a residential or commercial property and owned and operated by the resident of the property, providing the operator of the wireless access point with the opportunity to make efficient use of their network connection by sharing the connection with other users.

Preferably the wireless access point comprises: a base station for providing the wireless connection to the wireless enabled device; and a wireless access point controller for controlling the connection of the wireless enabled device to the network, wherein the wireless access point controller is a general purpose computer.

According to a second aspect of the invention there is provided a method of commissioning and controlling a wireless access point providing authenticated connection of a wireless enabled device to a network, the method comprising: providing a server accessible over the network by said wireless access point; providing storage means accessible by the server; storing in the storage means software providing means for the wireless access point to check with the server if a wireless enabled device can be connected to the network through the wireless access point; storing in the storage means subscription information accessible by the server to authenticate connection of the wireless enabled device to the network through the wireless access point; downloading the software from the storage means to the wireless access point; installing the software on the wireless access point; checking with the server if a wireless enabled device can be connected to the network through the wireless access point; and authenticating connection of the wireless enabled device to the network through the wireless access point based on the subscription information accessible by the server.

Preferably the bandwidth available at the wireless access point can be tested.

Preferably information about the wireless access point can be stored in the storage means, such as the bandwidth available at the wireless access point and information about the location of the wireless access point.

Preferably demand for a wireless access point in a specified geographical area is registered and stored in the storage means.

Preferably usage information relating to connection of a wireless enabled device to the network through the wireless access point is measured and stored in the storage means.

Preferably information stored in the storage means is accessible over the network for viewing on a web browser.

Preferably the wireless access point is in a residential or commercial property and owned and operated by the resident of the property, providing the operator of the wireless access point with the opportunity to make efficient use of their network connection by sharing the connection with other users.

Preferably the wireless access point comprises: a base station for providing the wireless connection to the wireless enabled device; and a wireless access point controller for controlling the connection of the wireless enabled device to the network, wherein the wireless access point controller is a general purpose computer.

According to a third aspect of the invention there is provided a method of determining demand for a service in a specified geographical area, the method comprising: providing means for registering a request for the service in the specified geographical area; and recording the number of requests registered for the service in the specified geographical area.

Preferably means are provided for enquiring about a presence of the service in the specified geographical area.

According to a fourth aspect of the invention there is provided a method of satisfying the demand for a service in a specified geographical area, the method comprising: providing means for enquiring about a presence of the service in the specified geographical area; providing means for registering a request for the service in the specified geographical area; recording the number of requests registered for the service in the specified geographical area; providing means for potential providers of the service in the specified geographical area to check the number of requests for the service in the specified geographical area; and potential providers of the service in the specified geographical area providing the service in the specified geographical area.

According to the third and fourth aspects of the invention, preferably contact information, such as an email address, for a person registering a request is recorded so that the person registering the request is contacted when the service is available in or near to the specified geographical area.

Preferably the service is wireless access to a network, preferably via a public wireless local area network access point.

According to a fifth aspect of the invention there is provided a server for authenticating connection of a wireless enabled device to a network through a wireless access point, said wireless access point comprising a base station for providing a wireless connection to said wireless enabled device and a general purpose computer for controlling the connection of said wireless enabled device to the network, the server being connected to storage means for storing information relating to authenticating the connection of the wireless enabled device to the network and for storing software downloadable to the wireless access point, the software providing means for the wireless access point to check with the server if the wireless enabled device can be connected to the network through the wireless access point based on the information relating to authenticating the connection of the wireless enabled device to the network.

Preferably the server is connected to the wireless access point via the network.

Preferably subscription information relating to the wireless enabled device and information about the wireless access point, such as the location of the wireless access point, is stored in the storage means and is accessible by the server.

Preferably the server further comprises means for testing bandwidth available at the wireless access point and this information is stored in the storage means.

Preferably information stored in the storage means about demand for a wireless access point in a specified geographical area is accessible by the server.

Preferably the information stored in the storage means can be accessed by the server, transmitted over the network and viewed using a web browser.

According to a further aspect of the invention there is provided a system for connecting a wireless enabled device to a network, the system comprising: a wireless access point connected to the network, the wireless access point for providing a wireless connection to said wireless enabled device, and for controlling the connection of the wireless enabled device to the network; authenticating means connected to the wireless access point via the network, the authenticating means for authenticating the connection of the wireless enabled device to the network; and storage means connected to the authenticating means, the storage means for storing information relating to authenticating the connection of the wireless enabled device to the network, the wireless access point comprising: a base station for providing the wireless connection to the wireless enabled device; and a wireless access point controller for controlling the connection of the wireless enabled device to the network, wherein the wireless access point controller is a general purpose computer.

According to a further aspect of the invention there is provided a method of connecting a wireless enabled device to a network, the method comprising: connecting a wireless access point to the network, the wireless access point providing a wireless connection to said wireless enabled device and controlling the connection of the wireless enabled device to the network; and authenticating the connection of the wireless enabled device to the network, the wireless access point comprising: a base station for providing the wireless connection to the wireless enabled device; and a wireless access point controller for controlling the connection of the wireless enabled device to the network, wherein the wireless access point controller is a general purpose computer.

The invention will be further described by way of example with reference to the accompanying drawings in which:

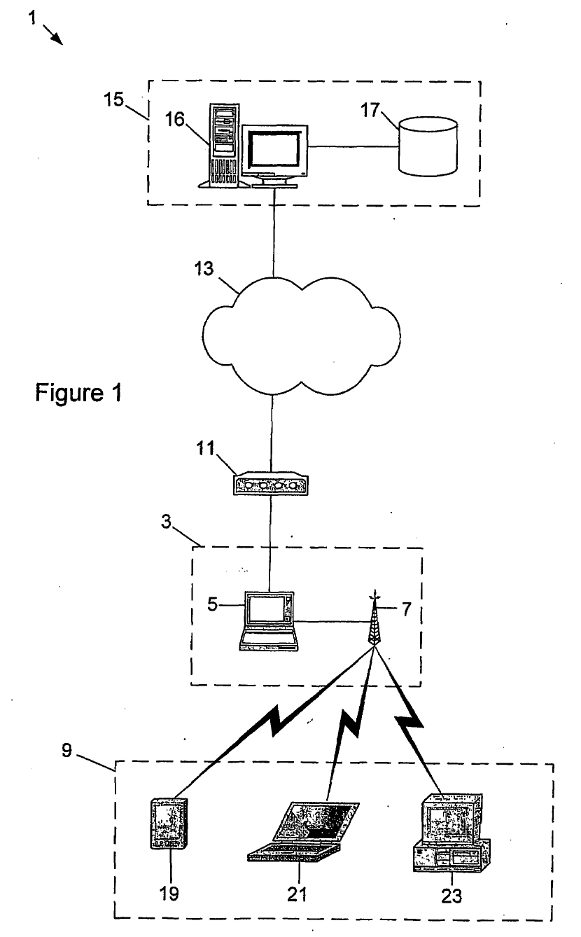

FIG. 1 is a schematic view of a network according to an embodiment of the invention; and

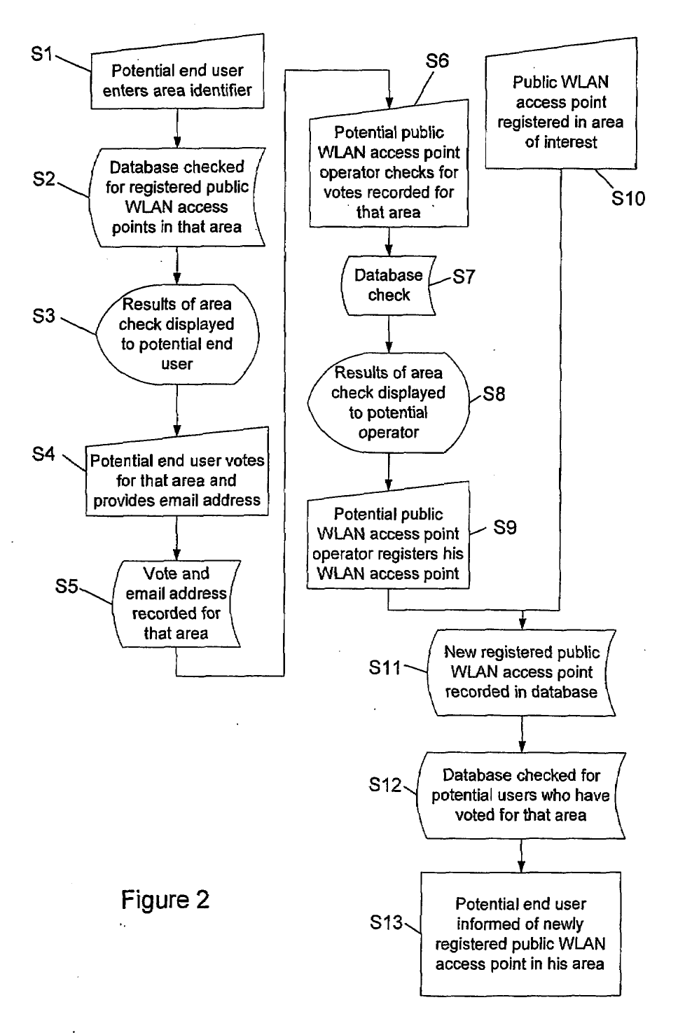

FIG. 2 is a flowchart showing the process of registering a request for a public WLAN access point to be set-up in a specific geographical area.

In FIG. 1, the ‘virtual’ network 1 is comprised of a public WLAN access point 3 which can be connected to a server 15 via the Internet 13 and provides a system for commissioning and controlling a wireless access point providing authenticated connection of a wireless enabled device 9 to the Internet 13.

The public WLAN access point 3 is comprised of an access point controller 5 and a base station 7. In this embodiment the access point controller 5 is a laptop. Alternatively, any general purpose computer can be used. In this embodiment the access point controller 5 runs a Windows® based operating system.

The server 15 is comprised of a server processor 16 and a storage means/database 17. In this embodiment the server processor 16 and storage means 17 are co-located. In other embodiments the server processor 16 may be remote from the storage means 17.

In this embodiment a modem 11 connects the public WLAN access point 3 to the Internet 13 using the services of an ISP (not shown). The skilled person will understand that any means for connecting the public WLAN access point 3 to the Internet, or other network, can be used, whether the connection is wired or wireless.

The storage means 17 holds information relating to operation of the public WLAN access point 3 and information relating to operation of other public WLAN access points which are registered with that server 15. The public WLAN access points which are registered with the server 15 and the server 15 itself form a virtual network 1 of public WLAN access points, any of which can be used by subscribers to the network 1, as is explained below.

A wireless enabled device 9 in range of the base station 7 can be connected to the Internet 13 through the public WLAN access point 3. The wireless enabled device 9 may be a personal digital assistant 19, a laptop 21, a desktop computer 23 or other device which can be connected wirelessly to the base station 7. Alternatively, the invention can be used to connect wired device to the Internet 13.

The access point controller 5 is loaded with software which controls access to the Internet 13 in conjunction with the server 15. The code required to install the software is available from the server 15 and can be downloaded over the Internet 13. No software is required to be installed on any of the wireless enabled devices 9 in order to connect to the Internet 13 through the public WLAN access point 3, other than industry standard wireless utility software which enables access to any compliant wireless network. Such wireless enabled devices 9 are typically compliant with the IEEE 802.11 specification and/or the Bluetooth specification. This invention is not limited to wireless enabled devices 9 and base stations 7 compliant with these specifications, rather the invention can be implemented for any such devices 7, 9 which can be connected wired or wirelessly.

In this embodiment, the access point controller 5 is connected by a wired connection to the base station 7. The skilled person will understand that in other embodiments, the access point controller 5 can be connected wirelessly to the base station 7.

As well as the storage means 17 containing information about the public WLAN access points 3 registered to use the virtual network 1, it also contains data about end users of wireless enabled devices 9 who subscribe to the network 1.

In use, when a wireless enabled device 9 is in range of the base station 7 it detects the presence of the public WLAN access point 3 and a wireless connection can be initiated between the wireless enabled device 9 and the public WLAN access point 3. When a web browser application is run on the wireless enabled device 9, the software installed on the access point controller 5 causes a login/sign-up page to be displayed on the web browser.

If the end user of the wireless enabled device 9 is not a subscriber of the virtual network 1 provided by the public WLAN access points 3 and the server 15, then the end user can enter personal information which is transmitted via the public WLAN access point 3 and the Internet 13 to the server processor 16, and which is stored on the storage device 17, thereby registering the end user. Once the end user of the wireless enabled device 9 has registered to use the virtual network 1, the end user of the wireless enabled device 9 purchases a service plan to provide roaming access to the Internet 13 using the virtual network 1 managed by the server 15. The service plan allows wireless access to the Internet 13 for a predetermined period of time, and the commencing and finishing times for the end user are recorded in the storage means 17.

Alternatively, end users of wireless enabled devices 9 may purchase a pre-registered account, for example an access card with login identifiers specific to that card, allowing wireless roaming access to the Internet 13 for a predetermined period of time or other measurable quantity (e.g., an amount of data). Such an access card is pre-registered with the storage means 17 to allow access to the Internet 13 without registering personal information about the end user.

End user access is authenticated by providing a username and password. Alternatively, the wireless enabled device 9 can be registered as an authenticated device, for example by providing the media access control (MAC) address of the device to the server 15.

Once the user of a wireless enabled device 9 purchases a service plan and inputs pertinent details on the login page, the access point controller 5 checks with the server 15 if the user of the wireless enabled device 9 can be connected to the Internet 13 via the public WLAN access point 3. The server 15 checks the subscription information stored in the storage means 17 and, if appropriate, authorises the access point controller 5 to allow full access to the Internet 13 to the end user of the wireless enabled device 9. In this manner, the server 15 acts as an authenticating means for authenticating connection of the wireless enabled device 9 to the Internet via the public WLAN access point 3.

As the end user of the wireless enabled device 9 has a unique user identification, the user is not limited to accessing the Internet 13 through the original public WLAN access point 3 at which he/she registered, but the end user of the wireless enabled device 9 can roam and use any public WLAN access point 3 which is registered with the server 15. For example, if a user of a wireless enabled device 9 purchases a service plan which enables access to the Internet 13 for one month, the user may access the Internet 13 via any public WLAN access point 3 which is registered with the server 15 at any time during the month following purchase of the service plan or initial access. Hence, the end user of the wireless enabled device 9 benefits from access to the Internet 13 from a plurality of locations.

The skilled person will understand that access to the Internet 13 is not limited to authentication by the specific server 15 shown in FIG. 1, but other servers with access to the storage means 17 can authenticate access to the Internet 13 through other public WLAN access points 3. Similarly, agreements can be put in place with operators of other public WLAN access points 3 to license access to each other's networks for their own subscribers.

As the public WLAN access point 3 is comprised of commonly available off-the-shelf devices (i.e., the access point controller 5 is a general purpose computer and the base station 7 is a radio transmitter conforming to industry standard specifications) any subscriber to an ISP service, whether a residential subscribers or a business subscriber, can download and install the software from the server 15 to commission a public WLAN access point 3 and register the public WLAN access point 3 with the server 15. In many cases, public WLAN access point 3 can be registered by individuals without purchasing any additional equipment, as general purpose computers and compliant base stations 7 are items owned by many individuals.

Hence, an advantage of the invention is that no specialist equipment or specialist commissioning is required to install a public WLAN access point 3. This is in contrast to many of the currently available commercial public WLAN access point offerings, which provide ‘black boxes’ to be installed at a host's site. A consequence of this advantage is that roll-out of this system is readily possible and it can be implemented by the averagely skilled computer user, without any specialist knowledge and without purchasing any specialist hardware. Furthermore, as the public WLAN access point 3 can be installed and maintained by the person residing at the site, the owner of the public WLAN access point 3 does not need to enter into any long-term contracts with a commercial public WLAN access point operator or pay fees to such an operator, which will encourage persons residing at both residential and commercial properties to install public WLAN access points 3 embodying this invention.

Hence, this invention facilitates widespread geographical coverage by public WLAN access points 3 at minimal cost compared to currently offered commercial public WLAN access point products.

As mentioned above, the storage means 17 contains usage information about the end users of the wireless enabled devices 9 as well as usage information about specific public WLAN access points 3. Therefore, owners of these public WLAN access points 3 can be remunerated for providing this service.

Various models can be used for remuneration. For example, the owner/operator of the public WLAN access point 3 can be paid a proportion of the amount of the initial purchase of a service plan which took place through their public WLAN access point 3. Alternatively, the owner can be remunerated based on the proportion of access provided to the subscribing end user of the wireless enabled device 9 through the owner's public WLAN access point 3. For example, if the end user of a wireless enabled device 9 purchases a 24-hour service plan, and the end user accesses the Internet 13 using two public WLAN access points 3 during that 24-hour period, a proportion of the purchase price may be divided between the owners of the two public WLAN access points 3. If so desired, the owner/operator of the public WLAN access points 3 can set his own pricing structure.

As mentioned above, the storage means 17 stores information about subscribing end users of the virtual network 1, and the owners/operators of registered public WLAN access points 3. Some of the data stored in the storage means 17 can be made available over the Internet 13 to potential end users of the virtual network 1, using a web browser, for example.

For example, if a potential end user of the virtual network 1 wishes to find out if there are any registered public WLAN access points 3 in a specific geographical area, the potential user can access the information which is stored in the storage means 17 using a web browser. This process is shown in FIG. 2. The potential end user inputs an area identifier S1, such as a postcode or zip code, and the server 15 accesses the storage means 17 S2 and returns the locations of registered public WLAN access points 3 in and/or near to the potential end user's target area S3.

A further aspect of the invention provides a potential end user with the ability to register a desire for a registered public WLAN access point 3 to be commissioned in a specific area, as further shown in FIG. 2. If, after interrogating the storage means 17, the potential user determines that there are no registered public WLAN access points 3 in his desired area, he can register personal details to indicate his desire for provision of such a public WLAN access point 3 in that area S4. Contact details, such as an email address, can be recorded to provide update information, as described below. The server processor 16 then stores this information in the storage means 17 as a ‘vote’ S5. This generates a list of area identifiers in the storage means 17 with a tally against each area identifier indicating the level of demand for a public WLAN access point 3 in that area. When subsequent enquiries are made regarding an area where a vote has been registered, the server 15 transmits the tally for that area S3 to the person making the enquiry.

Just as a potential end user in a geographical area can view this information, similarly a potential public WLAN access point operator can view this information.

If a potential public WLAN access point operator wishes to enquire about the demand for this service in his area, he can enter an area identifier to check for the number of votes recorded for that area S6. The database 17 is checked S7 and the results of the area check are returned to the enquirer S8. The potential public WLAN access point operator can then register his WLAN access point S9 with the server 15, to become part of the virtual network 1, and pertinent details are recorded S11 on the storage means 17.

After registration of a public WLAN access point 3, the server 15 checks S12 if any votes have been registered for that area, and if appropriate, potential end users who registered a vote for that area are contacted S13 by email to inform them of the expansion of the virtual network 1 to their desired area.

In a similar manner, if a public WLAN access point 3 is registered independently of checking the demand for this service in the area of the newly registered public WLAN access point 3 S10, potential end users are informed of the newly registered public WLAN access point 3 as described above S11-S13.

Hence, this feature of the invention monitors demand for public WLAN access points 3 in a specified geographical area, allows access to this information by potential operators of public WLAN access points 3 and informs potential end users in that area of the availability of the virtual network 1, thereby providing an efficient way of expanding the virtual network 1 into areas where there is demand for this service.

This invention is not limited to recording and providing information about the demand for provision of public WLAN access points 3 in a specified geographical area. Rather, it can be used to determine and satisfy the demand for any service in a specified geographical area.

For example, a retailer can use this invention to determine desirable locations to open a new store. A potential customer could search on a website for the location of the retailer's stores, and if the potential customer discovers that there is no store in close proximity to their desired location, they can register an interest in a store being set up in that area. Once their interest and contact details have been registered, the potential customer can be informed of any relevant developments in that regard.

The storage means 17 also stores information about the bandwidth available at each registered public WLAN access point 3. The process for recording this information is as follows. When the user of a wireless enabled device 9 is in range of a public WLAN access point 3, the user is provided with an opportunity, from the website displayed on the web browser of the wireless enable device 9, to test the bandwidth available at that public WLAN access point 3. Such bandwidth testing software is well known in the art and is commonly available from numerous websites. The user of the wireless enabled device 9 tests the bandwidth of the public WLAN access point using such a utility stored on the server 15, and the result of the bandwidth test is made available to the user of the wireless enabled device 9.

This information is also stored in the storage means 17 against that registered public WLAN access point 3, and is made available to end users and potential end users of the virtual network 1 when they enquire about locations of registered public WLAN access points 3.

The bandwidth available at a particular public WLAN access point 3 depends primarily on the bandwidth of the subscriber line provided by the public WLAN access point operator's ISP. The bandwidth available will also depend on the wireless connection speed between the base station 7 and the wireless enabled device 9. However, currently available base stations 7 operating according to the IEE 802.11 standard have a bandwidth much greater than bandwidths commonly provided by ISPs. Therefore, the primary limiting factor is the bandwidth provided by the ISP.

Many Broadband subscriber lines are provided at speeds governed by a 2ⁿ relationship, for example, a bandwidth of 512 kilo bits per second (Kbps) or 1.024 Mbps. Therefore, when the server 15 returns a bandwidth speed value to the public WLAN access point 3 to be provided to the wireless enabled device 9, and/or when the server 15 stores this value in the storage means 17, the value can be rounded up to the nearest standard bandwidth according to this relationship. For example, if the server 15 detects a bandwidth of 700 Kbps, it may return a value of 1.024 Mbps, to indicate that the operator of the pubic WLAN access point 3 subscribes to a 1.024 Mbps Broadband line. A particular advantage of this rounding up to the nearest commercially available speed is that the actual connection speed will vary from time to time, and a measured speed at one point in time is not necessarily indicative of a speed at another point in time. Hence, the storage means 17 can store and the server 15 can return an ideal value which will be known to be a nominal, but not actual, value by the averagely skilled user of Broadband subscriber lines.

Various modifications will be apparent to those in the art and it is desired to include all such modifications as fall within the scope of the accompanying claims. For example, the specific description describes a system for connecting a wireless enabled device to the Internet. However, the system could equally be used to connect a wired device to the Internet or to connect a device to any network.

1. A system for commissioning and controlling a wireless access point providing authenticated connection of a wireless enabled device to a network, the system comprising:
a server accessible over the network by said wireless access point; and
storage means accessible by the server;
wherein the storage means stores software downloadable to the wireless access point, the software providing means for the wireless access point to check with the server if said wireless enabled device can be connected to the network through the wireless access point; and
wherein the storage means stores subscription information accessible by the server to authenticate connection of said wireless enabled device to the network through the wireless access point.

2. A system as claimed in claim 1, wherein the server comprises means for testing bandwidth available at the wireless access point.

3. A system as claimed in claim 1, wherein the storage means stores information about the wireless access point.

4. A system as claimed in claim 3, wherein the storage means stores information about the bandwidth available at the wireless access point.

5. A system as claimed in claim 3, wherein the storage means stores information about the location of the wireless access point.

6. A system as claimed in claim 1, further comprising means for registering the demand for a wireless access point in a specified geographical area.

7. A system as claimed in claim 6, wherein the storage means stores information about the demand for a wireless access point in the specified geographical area.

8. A system as claimed in claim 1, further comprising means for measuring usage information relating to connection of a wireless enabled device to the network through the wireless access point, the measured usage information being stored in the storage means.

9. A system as claimed in claim 1, wherein information stored in the storage means can be accessed over the network and viewed using a web browser.

10. A system as claimed in claim 1, wherein the wireless access point is in a residential property.

11. A system as claimed in claim 1, wherein the wireless access point is in a commercial property.

12. A system as claimed in claim 10, wherein the wireless access point is owned by a person residing at the property.

13. A system as claimed in claim 1, wherein the wireless access point comprises:
a base station for providing the wireless connection to the wireless enabled device; and
a wireless access point controller for controlling the connection of the wireless enabled device to the network,
wherein the wireless access point controller is a general purpose computer.

14. A method of commissioning and controlling a wireless access point providing authenticated connection of a wireless enabled device to a network, the method comprising:
providing a server accessible over the network by said wireless access point;
providing storage means accessible by the server;
storing in the storage means software providing means for the wireless access point to check with the server if a wireless enabled device can be connected to the network through the wireless access point;
storing in the storage means subscription information accessible by the server to authenticate connection of the wireless enabled device to the network through the wireless access point;
downloading the software from the storage means to the wireless access point;
installing the software on the wireless access point;
checking with the server if a wireless enabled device can be connected to the network through the wireless access point; and
authenticating connection of the wireless enabled device to the network through the wireless access point based on the subscription information accessible by the server.

15. A method as claimed in claim 14, further comprising storing in the storage means information about the wireless access point.

16. A method as claimed in claim 14, further comprising testing bandwidth available at the wireless access point.

17. A method as claimed in claim 16, further comprising storing in the storage means information about the bandwidth available at the wireless access point.

18. A method as claimed in claim 15, further comprising storing in the storage means stores information about the location of the wireless access point.

19. A method as claimed in claim 14, further comprising providing means for registering demand for a wireless access point in a specified geographical area and storing in the storage means information about the demand for a wireless access point in the specified geographical area.

20. A method as claim in claim 14, further comprising measuring the usage information relating to connection of a wireless enabled device to the network through the wireless access point and storing this information in the storage means.

21. A method as claimed in claim 14, further comprising providing means for accessing information stored in the storage means over the network for viewing on a web browser.

22. A method as claimed in claim 14, wherein the wireless access point is in a residential property.

23. A method as claimed in claim 14, wherein the wireless access point is in a commercial property.

24. A method as claimed in claim 22, wherein the wireless access point is owned by a person residing at the property.

25. A method as claimed in claim 14, wherein the wireless access point comprises:
a base station for providing the wireless connection to the wireless enabled device; and
a wireless access point controller for controlling the connection of the wireless enabled device to the network,
wherein the wireless access point controller is a general purpose computer.

26. A method of determining demand for a service in a specified geographical area, the method comprising:
providing means for registering a request for the service in the specified geographical area; and
recording the number of requests registered for the service in the specified geographical area.

27. A method as claimed in claim 26, further comprising first providing means for enquiring about a presence of the service in the specified geographical area.

28. A method of satisfying the demand for a service in a specified geographical area, the method comprising:
providing means for enquiring about a presence of the service in the specified geographical area;
providing means for registering a request for the service in the specified geographical area;
recording the number of requests registered for the service in the specified geographical area;
providing means for potential providers of the service in the specified geographical area to check the number of requests for the service in the specified geographical area; and
potential providers of the service in the specified geographical area providing the service in the specified geographical area.

29. A method as claimed in claim 26, further comprising recording contact information for a person registering a request.

30. A method as claimed in claim 29, wherein the contact information is an email address.

31. A method as claimed in claim 29, wherein the person registering the request is contacted when the service is available in or near to the specified geographical area.

32. A method as claimed in claim 26, wherein the service is wireless access to a network.

33. A method as claimed in claim 32, wherein the wireless access to the network is provided via a public wireless local area network (WLAN) access point.

34. A server for authenticating connection of a wireless enabled device to a network through a wireless access point, said wireless access point comprising a base station for providing a wireless connection to said wireless enabled device and a general purpose computer for controlling the connection of said wireless enabled device to the network, the server being connected to storage means for storing information relating to authenticating the connection of the wireless enabled device to the network and for storing software downloadable to the wireless access point, the software providing means for the wireless access point to check with the server if the wireless enabled device can be connected to the network through the wireless access point based on the information relating to authenticating the connection of the wireless enabled device to the network.

35. A server as claimed in claim 34, wherein the server is connected to the wireless access point via the network.

36. A server as claimed in claim 34, wherein subscription information stored in the storage means relating to the wireless enabled device is accessible by the server.

37. A server as claimed in claim 34, wherein information stored in the storage means about the wireless access point is accessible by the server.

38. A server as claimed in claim 34, further comprising means for testing bandwidth available at the wireless access point.

39. A server as claimed in claim 38, wherein the server stores information to the storage means about the bandwidth available at the wireless access point.

40. A server as claimed in claim 37, wherein information stored in the storage means about the location of the wireless access point is accessible by the server.

41. A server as claimed in claim 34, wherein information stored in the storage means about demand for a wireless access point in a specified geographical area is accessible by the server.

42. A server as claimed in claim 34, wherein information stored in the storage means can be accessed by the server and transmitted over the network and viewed using a web browser.

43. A system for connecting a wireless enabled device to a network, the system comprising:
a wireless access point connected to the network, the wireless access point for providing a wireless connection to said wireless enabled device, and for controlling the connection of the wireless enabled device to the network;
authenticating means connected to the wireless access point via the network, the authenticating means for authenticating the connection of the wireless enabled device to the network; and
